(19) United States
(12) Patent Application Publication
(10) Pub. No.: US 2008/0229316 A1
(43) Pub. Date: Sep. 18, 2008

(54) DATA PROCESSING DEVICE AND ELECTRONIC DEVICE

(75) Inventor: Isao Akima, Ogaki (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/045,206

(22) Filed: Mar. 10, 2008

(30) Foreign Application Priority Data
Mar. 13, 2007 (JP) 2007-062991

(51) Int. Cl. G06F 9/46

(52) U.S. Cl. 718/103

(57) ABSTRACT

A data processing device includes: an execution unit; and a memory unit, wherein the memory unit stores a plurality of pre-processing data on which a processing is to be rendered at a plurality of times prior to a specified time; (1) when a value of specified pre-processing data at the specified time is in a range between a maximum value and a minimum value among values of the plurality of pre-processing data, the execution unit renders the processing on the specified pre-processing data; and (2) when the value of the specified pre-processing data is greater than the maximum value or smaller than the minimum value, the execution unit renders the processing on an arbitrary value that is deemed substantively in the range between the maximum value and the minimum value, instead of the value of the specified pre-processing data.

The entire disclosure of Japanese Patent Application No. 2007-062991, filed Mar. 13, 2007 is expressly incorporated by reference herein.

### BACKGROUND

1. Technical Field

The present invention relates to data processing devices that receive data that is at least temporally or spatially continuous, such as, voice data and moving picture data, and renders processing such as correction on the data. The invention also relates to electronic devices that include the data processing devices.

2. Related Art

A data processing device DP10 in related art shown in FIG. 10 sequentially renders processing (for example, color tone correction) on a plurality of temporally continuous images IM1-IM6. More specifically, the data processing device DP10 includes MPU 10. At time t1, the MPU 10 renders the processing on a value “52” of pre-processing data Da (t1), that is data before the processing, in a pixel PX (1, 1) composing an image IM1 at time t1, thereby obtaining a value “76” of post-processing data Db which is a result of the processing.

However, according to the data processing device DP10 of related art described above, for example, at time t6, even when pre-processing data Da (t6) at time t6 has a value “68” that is substantially different, as a result of external influence such as noise, from values “53,” “52,” “53,” “51” and “55” of preceding pre-processing data Da (t1) through Da (t5) prior to time t6, the MPU 10 renders the same processing on the value “68” of the pre-processing data Da (t6) as rendered at time t1 through t5, and therefore post-processing data Db (t6) at time t6 has a value “99,” which is substantially different from values “76,” “73,” “76,” “72” and “80” of other post-processing data Db (t1) through Db (t5) at time t1 through time t5, which results in a problem in that the visibility of an image IM6 may be deteriorated.

### SUMMARY

In accordance with an advantage of some aspects of the invention, there is provided a data processing device that can substantially prevent the effect that is to be essentially given by succeeding data from being deteriorated as a result of influence of external disturbance, compared to the effect that is given by preceding data.

A first data processing device in accordance with an embodiment of the invention pertains to a data processing device including an execution unit and a memory unit, wherein the memory unit stores a plurality of pre-processing data on which a processing is to be rendered at a plurality of times prior to a specified time; (1) when a value of specified pre-processing data at the specified time is in a range between a maximum value and a minimum value among values of the plurality of pre-processing data, the execution unit renders the processing on the specified pre-processing data; and (2) when a value of the specified pre-processing data is greater than the maximum value or smaller than the minimum value, the execution unit renders the processing on an arbitrary value that is deemed to be substantively in the range between the maximum value and the minimum value, instead of the value of the specified pre-processing data.

According to the first data processing device in accordance with the embodiment of the invention described above, at the specified time, when a value of the specified pre-processing data at the specified time is greater than the maximum value or smaller than the minimum value among the plurality of pre-processing data at a plurality of times preceding to the specified time stored in the memory unit, the execution unit renders the processing on an arbitrary value that is deemed to be substantively in the range between the maximum value and the minimum value, instead of the value of the specified pre-processing data. By this, the influence of external disturbance that may have been inflicted on the specified pre-processing data can be reduced. Therefore, in contrast to the related art described above, it is possible to suppress deterioration of the effect (for example, excellent audibility and visibility) that should essentially be given by the specified post-processing data, which may be caused by the influence of external disturbance, compared to the effect that is given by the plurality of post-processing data.

A second data processing device in accordance with an embodiment of the invention pertains to a data processing device including an execution unit and a memory unit, wherein the execution unit obtains a plurality of post-processing data by rendering a processing on a plurality of pre-processing data to be processed at a plurality of times prior to a specified time; the memory unit stores the plurality of post-processing data; (1) the execution unit obtains specified post-processing data by rendering the processing on specified pre-processing data at the specified time; and (2) when the specified post-processing data is greater than a maximum value or smaller than a minimum value among values of the plurality of post-processing data, the execution unit replaces the specified post-processing data with an arbitrary value that is deemed to be substantively within the range between the maximum value and the minimum value.

According to the second data processing device in accordance with the embodiment of the invention described above, at the specified time, when a value of specified post-processing data at the specified time is greater than the maximum value or smaller than the minimum value among the values of the plurality of post-processing data obtained at a plurality of times prior to the specified time and stored in the memory unit, the execution unit replaces the specified post-processing data with a value that is deemed to be substantively within the range between the maximum value and the minimum value. By this, like the first data processing device in accordance with the embodiment described above, the influence of external disturbance that may have been given to the specified pre-processing data can be reduced. Therefore, in contrast to the related art described above, it is possible to suppress deterioration of the effect (for example, excellent audibility and visibility) that is to be essentially given by the specified post-processing data, which may be caused by the influence of external disturbance, compared to the effect that is rendered on the plurality of post-processing data.

In the first and second data processing devices in accordance with the embodiment described above, the memory unit may store a processing table that specifies relation between pre-processing data and post-processing data that is a result obtained by rendering the processing on the pre-processing data, and the execution unit may render the processing through looking up the processing table stored in the memory unit.

In the first data processing device in accordance with the embodiment described above, the plurality of pre-processing data and the specified pre-processing data may require sequential rendering of the processing, and the memory unit may be a ferroelectric memory. When a failure in power supply to the ferroelectric memory occurs from the time the processing on the plurality of pre-processing data is completed until the time the processing on the specified pre-processing data is started, the execution unit judges, upon restoring the power supply, whether a value of pre-processing data at the specified time is within the range between the maximum value and the minimum value of the plurality of pre-processing data obtained before the occurrence of the power supply failure and stored in the ferroelectric memory.

In the second data processing device in accordance with the embodiment described above, the plurality of pre-processing data and the specified pre-processing data may require sequential rendering of the processing, and the memory unit may be a ferroelectric memory. When a failure in power supply to the ferroelectric memory occurs from the time the processing on the plurality of pre-processing data is completed until the time the processing on the specified pre-processing data is started, the execution unit judges upon restoring the power supply whether a value of post-processing data at the specified time is within the range between the maximum value and the minimum value of the plurality of post-processing data obtained before the occurrence of the power supply failure and stored in the ferroelectric memory.

A third data processing device in accordance with an embodiment of the invention pertains to a data processing device including an execution unit and a memory unit, wherein the memory unit stores a plurality of pre-processing data that is physically in proximity to pre-processing data on which a processing is to be rendered; (1) when a value of the specified pre-processing data is in the range between a maximum value and a minimum value among values of the plurality of pre-processing data, the execution unit renders the processing on the specified pre-processing data; and (2) when the value of the specified pre-processing data is greater than the maximum value or smaller than the minimum value, the execution unit renders the processing on an arbitrary value that is deemed to be substantively within the range between the maximum value and the minimum value, instead of the value of the specified pre-processing data.

A fourth data processing device in accordance with an embodiment of the invention pertains to a data processing device including an execution unit and a memory unit, wherein the execution unit obtains a plurality of post-processing data by rendering a processing on a plurality of pre-processing data physically in proximity to specified pre-processing data to be processed; the memory unit stores the plurality of post-processing data; (1) the execution unit obtains specified post-processing data by rendering the processing on the specified pre-processing data; and (2) when the value of the specified post-processing data is greater than a maximum value or smaller than a minimum value among values of the plurality of post-processing data, the execution unit replaces the value of the specified post-processing data with an arbitrary value that is deemed to be substantively within the range between the maximum value and the minimum value.

In the third and fourth data processing device in accordance with the embodiment described above, the memory unit may store a processing table that specifies relation between pre-processing data and post-processing data that is a result obtained by rendering the processing on the pre-processing data, and the execution unit may render the processing through looking up the processing table stored in the memory unit.

An electronic device in accordance with an embodiment of the invention includes any one of the first-fourth data processing devices described above.

### BRIEF DESCRIPTION OF THE DRAWINGS

FIG. 1 is a schematic diagram of a data processing device in accordance with an embodiment of the invention.

FIG. 2 shows contents of a processing table in accordance with the embodiment.

FIG. 3 shows contents of data status in accordance with the embodiment.

FIG. 4 is a flow chart of operations of the data processing device in accordance with the embodiment.

FIG. 5 shows contents of data status in accordance with a modified example 1.

FIG. 6 is a flow chart of operations of the data processing device in accordance with the modified example 1.

FIG. 7 is a figure showing pixels in an image in accordance with a modified example 2.

FIG. 8 shows contents of data status in accordance with the modified example 2.

FIG. 9 shows contents of data status in accordance with a modified example 3.

FIG. 10 is a schematic diagram of a data processing device in related art.

FIG. 11 is a figure of an image in related art.

### DESCRIPTION OF EXEMPLARY EMBODIMENTS

A data processing device in accordance with an embodiment of the invention is described with reference to the accompanying drawings.

### Embodiments

Structure

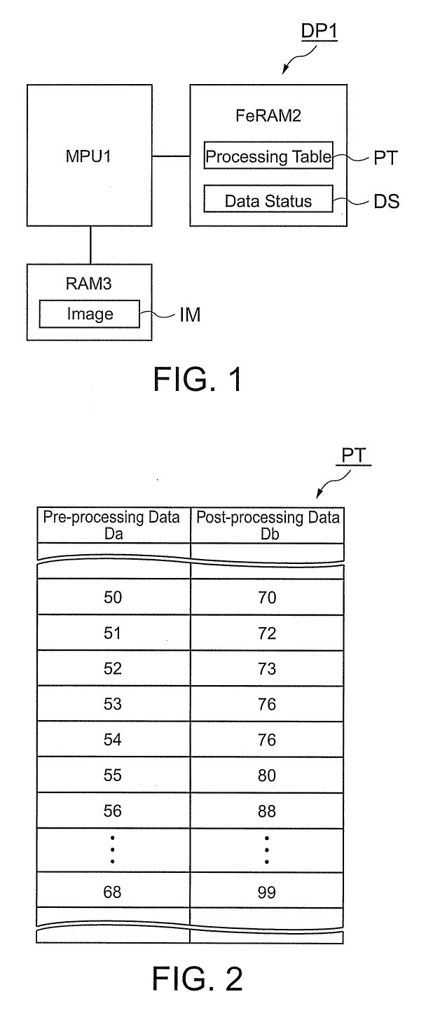

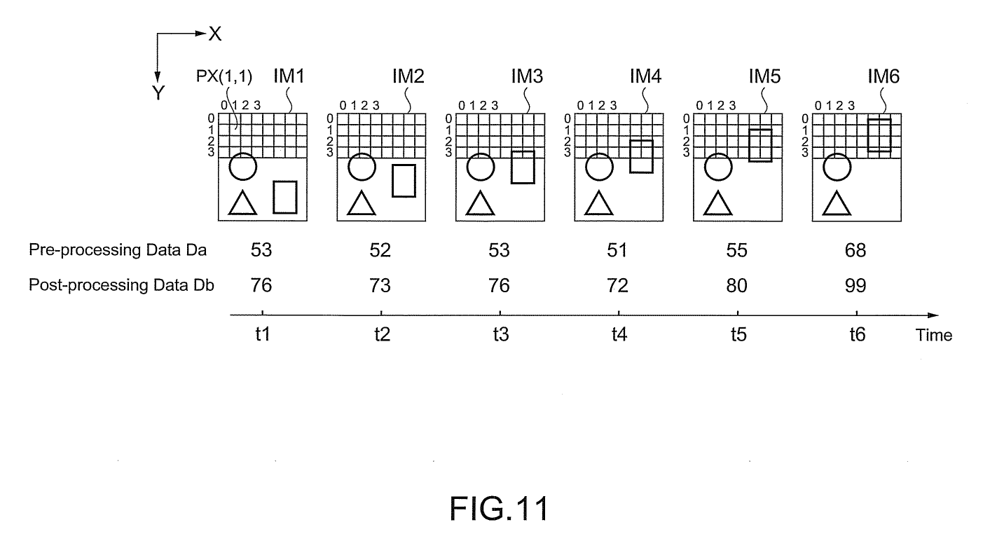

A data processing device DP1 in accordance with an embodiment of the invention includes MPU1, FeRAM 2 and RAM 3, as shown in FIG. 1, for rendering predetermined processing (for example, color tone correction) on a plurality of images IM1-IM6 that are received by the data processing device DP1 from outside, similar to the processing shown in FIG. 11.

The MPU 1 that is an “execution unit” renders the processing on the image IM1-IM6 according to a program (not shown) that stipulates contents of the processing with reference to a processing table PT and a data status DS stored in the FeRAM 2.

The ReRAM 2 that is a “memory unit” is a ferroelectric memory having non-volatility. The FeRAM 2 stores the processing table PT and the data status DS.

The processing table PT stipulates relation between pre-processing data Da that are data before rendering of the processing (for example, pre-processing data Da (t1) at time t1), which may possibly be given by each of plural pixels (for example, pixel PX (1, 1) in FIG. 11) composing each of the images IM1-IM6, and post-processing data Db that are results obtained by rendering the processing on the pre-processing data Da (for example, post-processing data Db (t1) that is a result obtained by rendering the processing on the pre-processing data Da (t1)). The processing table PT, for example, shows that a value “50” of pre-processing data Da corresponds to a value “70” of post-processing data Db, and shows that a value “51” of pre-processing data Da corresponds to a value “72” of post-processing data Db.

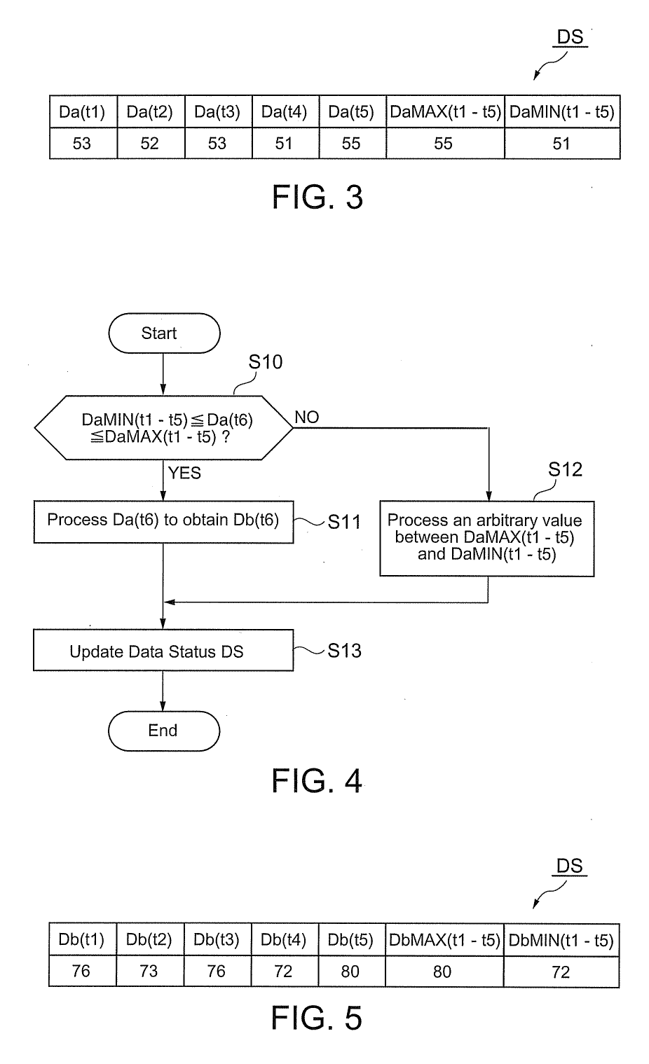

At time t6, in other words, when the processing is to be rendered on the image IM6, as shown in FIG. 3, the data status DS has already stored values “53,” “52,” “53,” “51” and “55” of pre-processing data Da (t1)-Da (t5) at times t1-t5 preceding to time t6 shown in FIG. 11, and also stores the largest value “55” of the maximum pre-processing data DaMAX (t1-t5) and the smallest value “51” of the minimum pre-processing data DaMIN (t1-t5) among the pre-processing data Da (t1)-Da (t5).

The RAM 3 temporarily stores the images IM1-IM6 received by the data processing device DP1 from outside, and also temporarily stores data that is required by the MPU 1 to perform the processing.

Operation

Operations of the data processing device in accordance with the present embodiment are described with reference to a flow chart shown in FIG. 4. For easier description and understanding, the operations shall be described assuming that the processing on the image IM1-IM5 at time t1-t5 has been completed, and the processing is to be rendered on the image IM 6 at time 6, and in particular, the processing is to be rendered on a pixel PX (1, 1) in the image IM6.

Step S10: The MPU 1 reads from the RAM 3 the value “68” of the pre-processing data Da (t6) of the pixel PX (1, 1) of the image IM6 stored in the RAM 3. Further, the MPU 1 judges as to whether the readout pre-processing data Da (t6) is less than the value “55” of the maximum pre-processing data DaMAX (t1-t5) among the data status DS stored in the FeRAM 2, namely, among the pre-processing data Da (t1)-Da (t5) at time t1-t5, and greater than the value “51” of the minimum pre-processing data DaMIN (t1-t5) among the pre-processing data Da (t1)-Da (t5) at time t1-t5.

Step S11: When the judgment is “YES” in step S10, the MPU 1 looks up the processing table PT stored in the FeRAM 2 and renders the processing on the pre-processing data Da (t6), thereby obtaining a value of the post-processing data Db (t6).

Step S12: When the judgment is “NO” in step S10, the MPU 1 assigns a value that is deemed to be located substantively between the value “55” of the maximum pre-processing data DaMAX (t1-t5) and the value “51” of the minimum pre-processing data DaMIN (t1-t5) (for example, an average value “53” of the pre-processing data Da (t1)-Da (t5)) as the pre-processing data Da (t6), instead of the value “68” of the pre-processing data Da (t6), looks up the processing table PT and renders the processing on the value “53” to obtain a value “76” as the processing result, and assigns the value “76” of the processing result as the post-processing data Db (t6) of the pixel PX (1, 1) of the image IM6 at time t6, instead of post-processing data Db (t6) that would have been obtained if the processing had been rendered on the value “68” of the pre-processing data Da.

Step S13: The MPU 1 stores the value “53” assigned as the pre-processing data Da (t6) in the FeRAM 2 thereby updating the data status DS, like the other pre-processing data Da (t1)-Da (t5) in the data status DS stored in the FeRAM 2, such that operations similar to those described above can be performed at time t7 (not shown) succeeding time t6.

Effect

According to the data processing device PD1 of the embodiment described above, the MPU 1 judges, based on the values of the maximum pre-processing data DaMAX (t1-t5) and the minimum pre-processing data DaMIN (t1-t5) among the pre-processing data Da (t1)-Da (t5) at time t1-t5 stored in the FeRAM 2, as to whether it is appropriate to use the value of the pre-processing data Da (t6) in the image IM6 at time t6 as is. When it is judged to be inappropriate, the MPU 1 assigns an arbitrary value “53” that is deemed to be located substantively in the range between the value “55” of the maximum pre-processing data DaMAX (t1-t5) and the value “51” of the minimum pre-processing data DaMIN (t1-t5) as the pre-processing data Da (t6), and uses the resultant value “76” obtained through rendering the processing on the value “53.” As a result, the influence of external disturbance that may possibly be included in the value “68” of the pre-processing data Da (t6) can be eliminated, such that the visibility of the image IM6 can be increased compared to related art.

According to the data processing device PD1 of the embodiment example described above, the MPU 1 obtains the post-processing data Db (t6) by simply looking up the processing table PT stored in the FeRAM 2, not by rendering the processing on the pre-processing data Da (t6), such that the processing load on the MPU 1 can be alleviated.

According to the data processing device PD1 of the embodiment example described above, when the processing needs to be sequentially rendered on the images IM1-IM6, and for example, a transient power supply failure occurs and then the power supply is recovered between time t5 and time t6, the FeRAM 2 continues storing the data status DS stored prior to the occurrence of the power supply failure. Therefore, when rendering the processing on the image IM6 at time t6, the MPU 1 can perform the processing, looking up the newest data status DS that has been most recently updated as described above.

### MODIFIED EXAMPLE 1

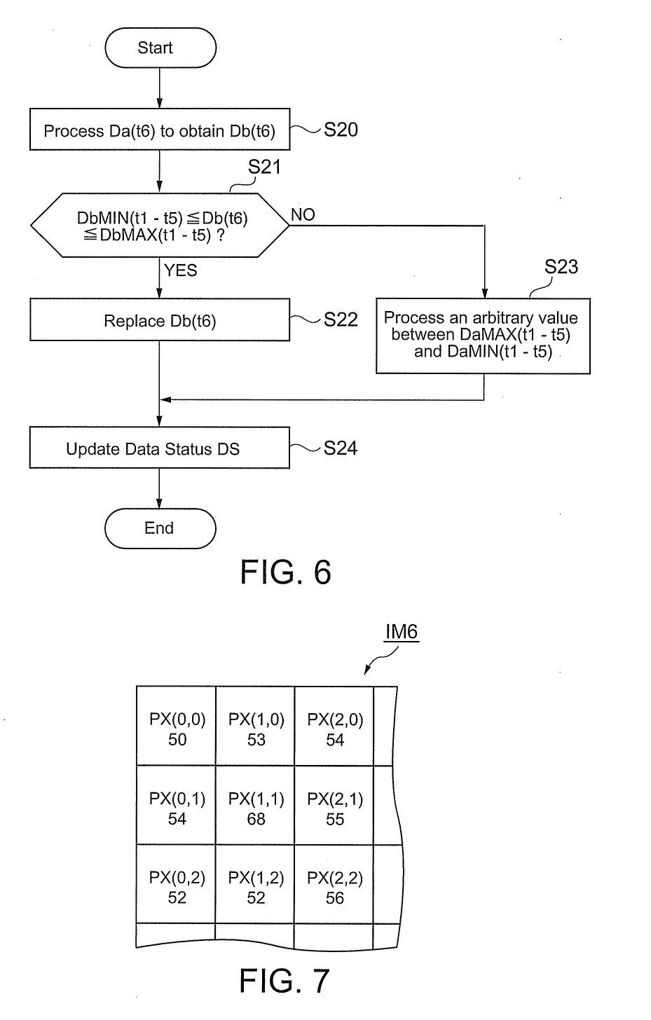

A data processing device DP1 in accordance with a modified example 1 includes MPU 1, FeRAM 2 and RAM 3, like the data processing device DP1 of the embodiment shown in FIG. 1. On the other hand, the data processing device DP1 in accordance with the modified example 1 makes a judgment as to whether the pre-processing data Da (t6) of the pixel PX (1, 1) in the image IM6 at time 6 is appropriate or not by comparing post-processing data Db (t6) with post-processing data Db (t1)-Db (t5), unlike the data processing device DP1 of the embodiment described above which makes the judgment by comparing the pre-processing data Da (t6) with the pre-processing data Da (t1)-Da (t5). In order to accomplish the above, the FeRAM 2 stores data status DS shown in FIG. 5, instead of the data status DS shown in FIG. 3, and the MPU 1 performs operations shown in FIG. 6, instead of the operations shown in FIG. 4.

According to the data processing device DP1 of the modified example 1, at time t6, in other words, when the processing is rendered on the image IM6, the data status DS stored in the FeRAM 2 stores values “76,” “73,” “76,” “72” and “80” of post-processing data Db (t1)-Db (t5), as shown in FIG. 5, which are obtained by rendering the processing on the pre-processing data Da (t1)-Da (5) at time t1-t5 prior to time t6 shown in FIG. 11, and also stores the largest value “80” of the maximum post-processing data DbMAX (t1-t5) and the smallest value “72” of the minimum post-processing data DbMIN (t1-t5) among the post-processing data Db (t1)-Db (t5).

Operation

Operations of the data processing device in accordance with the modified example 1 are described with reference to a flow chart shown in FIG. 6. For easier description and understanding, the operations shall be described assuming that the processing on the image IM1-IM5 at time t1-t5 has been completed, and the processing is to be rendered on the image IM 6 at time 6, and in particular, the processing is to be rendered on a pixel PX (1, 1) in the image IM6.

Step S20: The MPU 1 reads from the RAM 3 the value “68” of the pre-processing data Da (t6) of the pixel PX (1, 1) of the image IM6 stored in the RAM 3. Further, the MPU 1 looks up the processing table PT stored in the FeRAM 2 and renders the processing on the value “68” of the pre-processing data Da (t6), thereby obtaining a value “99” of the post-processing data Db (t6).

Step S21: The MPU 1 makes a judgment as to whether the obtained value “99” of the post-processing data Db (t6) is less than the value “80” of the maximum post-processing data DbMAX (t1-t5) among the data status DS stored in the FeRAM 2, namely, among the values of the post-processing data Db (t1)-Db (t5) at time t1-t5, and greater than the value “72” of the minimum post-processing data DbMIN (t1-t5) among the values of the post-processing data Db (t1)-Db (t5) at time t1-t5.

Step S22: When the judgment is “YES” in step S21, the MPU1 uses the value of the post-processing data Db (t6) as is.

Step S23: When the judgment is “NO” in step S21, the MPU 1 replaces the value “99” of the post-processing data Db (t6) with a value that is deemed to be located substantively between the value “80” of the maximum post-processing data DbMAX (t1-t5) and the value “72” of the minimum post-processing data DbMIN (t1-t5) (for example, an average value “75” of the post-processing data Db (t1)-Db (t5)).

Step S24: The MPU 1 stores the value “75” of the post-processing data Db (t6) in the FeRAM 2 thereby updating the data status DS, like the other post-processing data Db (t1)-Db (t5) in the data status DS stored in the FeRAM 2, such that operations similar to those described above can be performed at time t7 (not shown) succeeding time t6.

Effect

According to the data processing device PD1 of the modified example described above, the MPU 1 judges, based on the values of the maximum post-processing data DbMAX (t1-t5) and the minimum post-processing data DbMIN (t1-t5) among the post-processing data Db (t1)-Db (t5) at time t1-t5 stored in the FeRAM 2, as to whether it is appropriate to use the value of the post-processing data Db (t6) at time t6 as is. When it is judged to be inappropriate, the MPU 1 replaces the value “99” of the post-processing data Db (t6) with an arbitrary value “75” that is deemed to be located substantively in the range between the value “80” of the maximum post-processing data DbMAX (t1-t5) and the value “72” of the minimum post-processing data DbMIN (t1-t5). As a result, the influence of external disturbance that may possibly be included in the pre-processing data Da (t6) at time t6 can be eliminated, like the data processing device DP1 in accordance with the embodiment, such that the visibility of the image data can be increased compared to related art.

According to the data processing device PD1 of the modified example 1, as the post-processing data Db (t6) is obtained by simply looking up the processing table PT, like the data processing device DP1 of the embodiment, the processing load on the MPU 1 can be alleviated.

According to the data processing device PD1 of the modified example 1, when the processing needs to be sequentially rendered on the images IM1-IM6, and for example, a transient power supply failure occurs and then the power supply is recovered between time t5 and time t6, the FeRAM 2 continues storing the data status DS stored prior to the occurrence of the power supply failure. Therefore, when rendering the processing on the image IM6 at time t6, the MPU 1 can perform the processing, looking up the newest data status DS that has been most recently updated as described above.

### MODIFIED EXAMPLE 2

When processing a pixel PX (1, 1) in an image IM6 at time t6, a data processing device DP1 in accordance with a modified example 2 looks up other pixels physically relating to the pixel PX (1, 1) at time t6, for example, eight pixels PX (0, 0)-PX (2, 2) adjacent to and around the pixel PX (1, 1), as shown in FIG. 7, unlike the data processing device DP1 of the embodiment or the modified example 1 described above which looks up values of temporarily related other pixels, such as, the values of the pixel PX (1, 1) in the images IM1-IM5 at times t1-t5 preceding to time t6 (the values of the pre-processing data Da (t1)-Da (t5) or the post-processing data Db (t1)-Db (t5)).

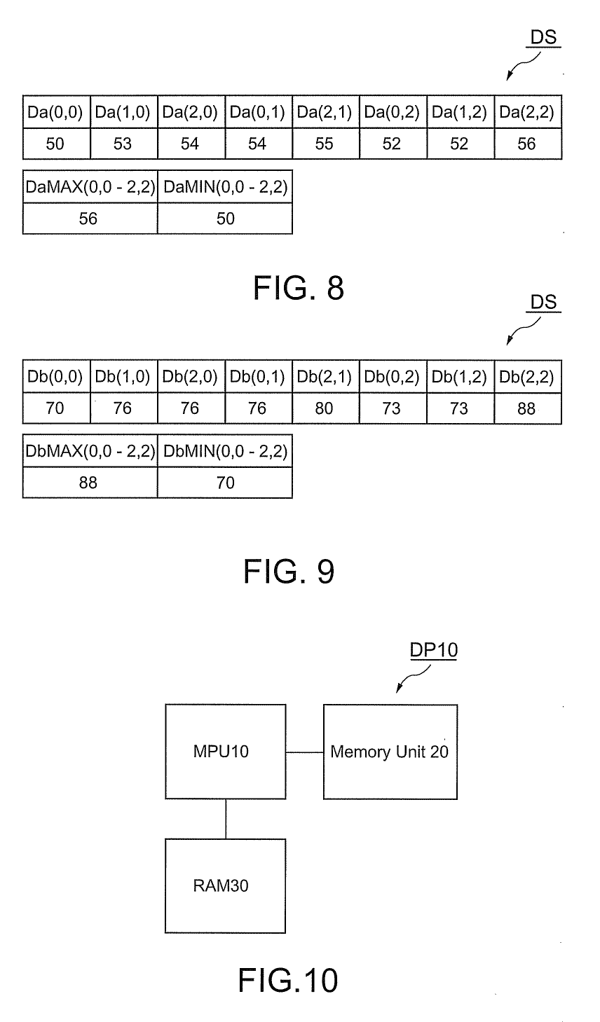

Data status DS stored in the FeRAM 2 preliminarily stores values “50”-“56” of pre-processing data Da (0, 0)-Da (2, 2) of the surrounding pixels PX (0, 0)- PX (2, 2) at time t6, as shown in FIG. 8, and also stores a value “56” of the maximum pre-processing data DaMAX (0, 0-2, 2) and a value “50” of the minimum pre-processing data DaMIN (0, 0-2, 2) among the pre-processing data Da (0, 0)-Da (2, 2) of the surrounding pixels PX (0, 0)- PX (2, 2).

According to the data processing device DP1 of the modified example 2, the MPU 1 makes a judgment, according to the flowchart in FIG. 4 showing operations of the data processing device DP1 of the embodiment 1, as to whether the value “68” of the pre-processing data Da (1, 1) is less than the value “56” of the maximum pre-processing data DaMAX (0, 0-2, 2) and greater than the value “50” of the minimum pre-processing data DaMIN (0, 0-2, 2). Based of the result of judgment, the MPU 1 may use the value “68” of the pre-processing data Da (1, 1) as is to obtain post-processing data Db (t6), or may assign, instead of the value “68” of the pre-processing data Da (1, 1), a value that is deemed to be located substantively between the value “56” of the maximum pre-processing data DaMAX (0, 0-2, 2) and the value “50” of the minimum pre-processing data DaMIN (0, 0-2, 2), for example, an average value “53” of the pre-processing data Da (0, 0)-Da (2, 2), and render the processing on the value “53” to obtain post-processing data Db (t6). As a result, the influence of external disturbance that may possibly be included in the pre-processing data Da (t6) can be eliminated, like the data processing device DP1 in accordance with the embodiment, such that the visibility of the image IM6 can be increased compared to related art.

### MODIFIED EXAMPLE 3

When processing a pixel PX (1, 1) in an image IM6 at time t6, a data processing device DP1 in accordance with a modified example 3 looks up other pixels physically relating to the pixel PX (1, 1) at time t6, for example, eight pixels PX (0, 0)-PX (2, 2) adjacent to and around the pixel PX (1, 1), like the data processing device DP1 in accordance with the modified example 2, as shown in FIG. 7. On the other hand, the data processing device DP1 in accordance with the modified example 3 looks up post-processing data Db (0, 0)-Db (2, 2) of the pixels PX (0, 0)- PX (2, 2), which is different from the data processing device DP1 in accordance with the modified example 2 that looks up the pre-processing data Da (0, 0)-Da (2, 2) of the pixels PX (0, 0)-PX (2, 2).

Data status DS stored in the FeRAM 2 preliminarily stores values “70”-“88” of post-processing data Db (0, 0)-Db (2, 2) of the surrounding pixels PX (0, 0)-PX (2, 2) at time t6, as shown in FIG. 9, and also stores a value “88” of the maximum post-processing data DbMAX (0, 0-2, 2) and a value “70” of the minimum post-processing data DbMIN (0, 0-2, 2) among the post-processing data Db (0, 0)-Db (2, 2) of the surrounding pixels PX (0, 0)-PX (2, 2).

According to the data processing device DP1 of the modified example 3, the MPU 1 makes a judgment, according to the flowchart in FIG. 6 showing operations of the data processing device DP1 of the modified example 2, as to whether the value “99” of the post-processing data Db (1, 1) is less than the value “88” of the maximum post-processing data DbMAX (0, 0-2, 2) and greater than the value “70” of the minimum post-processing data DbMIN (0, 0-2, 2). Based of the result of judgment, the MPU 1 may use the value “99” of the post-processing data Db (1, 1) as is, or may replace the value “99” of the post-processing data Da (1, 1) with a value that is deemed to be located substantively between the value “88” of the maximum post-processing data DbMAX (0, 0-2, 2) and the value “70” of the minimum post-processing data DbMIN (0, 0- 2, 2), for example, an average value “76” of the post-processing data Db (0, 0)-Db (2, 2), and render the processing on the value “76.” As a result, the influence of external disturbance that may possibly be included in the pre-processing data Da (t6) at time t6 can be eliminated, like the data processing device DP1 in accordance with the modified example 2, such that the visibility of the image IM6 can be increased compared to related art.

### OTHER EMBODIMENT EXAMPLES

Electronic devices in accordance with other embodiments of the invention include, for example, personal computers, cellular phones, digital cameras, and the like, which perform information processing, voice processing and image processing, and include any one of the data processing devices DP1 in accordance with the embodiment, and the modified examples 1-3 described above. According to the electronic devices of the other embodiment examples, operations similar to those of the embodiment and the modified examples 1-3 are performed on information data, voice data and image data (corresponding to the pre-processing data Da and post-processing data Db described above) which are subject to the information processing, voice processing and image processing described above, whereby effects similar to those described above can be obtained.

What is claimed is:

1. A data processing device comprising:
an execution unit; and
a memory unit, wherein
the memory unit stores a plurality of pre-processing data on which a processing is to be rendered at a plurality of times prior to a specified time;
(1) when a value of specified pre-processing data at the specified time is in a range between a maximum value and a minimum value among values of the plurality of pre-processing data, the execution unit renders the processing on the specified pre-processing data; and
(2) when the value of the specified pre-processing data is greater than the maximum value or smaller than the minimum value, the execution unit renders the processing on an arbitrary value that is deemed substantively in the range between the maximum value and the minimum value, instead of the value of the specified pre-processing data.

2. A data processing device comprising:
an execution unit; and
a memory unit, wherein
the execution unit obtains a plurality of post-processing data by rendering a processing on a plurality of pre-processing data to be processed at a plurality of times prior to a specified time;
the memory unit stores the plurality of post-processing data;
(1) the execution unit obtains specified post-processing data by rendering the processing on specified pre-processing data at the specified time; and
(2) when the specified post-processing data is greater than a maximum value or smaller than a minimum value among values of the plurality of post-processing data, the execution unit replaces the specified post-processing data with an arbitrary value that is deemed to be located substantively within the range between the maximum value and the minimum value.

3. A data processing device according to claim 1, wherein the memory unit stores a processing table that specifies relation between pre-processing data and post-processing data that is a result obtained by rendering the processing on the pre-processing data, and the execution unit renders the processing with reference to the processing table stored in the memory unit.

4. A data processing device according to claim 1, wherein
the plurality of pre-processing data and the specified pre-processing data require sequential rendering of the processing;
the memory unit is a ferroelectric memory; and
when a failure in power supply to the ferroelectric memory occurs from the time the processing on the plurality of pre-processing data is completed until the time the processing on the specified pre-processing data is started, the execution unit judges, upon restoring the power supply, whether a value of pre-processing data at the specified time is within the range between the maximum value and the minimum value among values of the plurality of pre-processing data obtained before the occurrence of the power supply failure and stored in the ferroelectric memory.

5. A data processing device according to claim 2, wherein
the plurality of pre-processing data and the specified pre-processing data requires sequential rendering of the processing;
the memory unit is a ferroelectric memory; and
when a failure in power supply to the ferroelectric memory occurs from the time the processing on the plurality of pre-processing data is completed until the time the processing on the specified pre-processing data is started, the execution unit judges, upon restoring the power supply, whether a value of post-processing data at the specified time is within the range between the maximum value and the minimum value among values of the plurality of post-processing data obtained before the occurrence of the power supply failure and stored in the ferroelectric memory.

6. A data processing device comprising:
an execution unit; and
a memory unit, wherein
the memory unit stores a plurality of pre-processing data that is physically in proximity to pre-processing data on which a processing is to be rendered;
(1) when a value of the specified pre-processing data is in the range between a maximum value and a minimum value among values of the plurality of pre-processing data, the execution unit renders the processing on the specified pre-processing data; and
(2) when the value of the specified pre-processing data is greater than the maximum value or smaller than the minimum value, the execution unit renders the processing on an arbitrary value that is deemed to be located substantively within the range between the maximum value and the minimum value, instead of the value of the specified pre-processing data.

7. A data processing device comprising:
an execution unit; and
a memory unit, wherein
the execution unit obtains a plurality of post-processing data by rendering a processing on a plurality of pre-processing data physically in proximity to specified pre-processing data to be processed;
the memory unit stores the plurality of post-processing data;
(1) the execution unit obtains specified post-processing data by rendering the processing on the specified pre-processing data; and
(2) when the value of the specified post-processing data is greater than a maximum value or smaller than a minimum value among values of the plurality of post-processing data, the execution unit replaces the value of the specified post-processing data with an arbitrary value that is deemed to be located substantively within the range between the maximum value and the minimum value.

8. A data processing device according to claim 6, wherein the memory unit stores a processing table that specifies relation between pre-processing data and post-processing data that is a result obtained by rendering the processing on the pre-processing data, and the execution unit renders the processing with reference to the processing table stored in the memory unit.

9. An electronic device comprising the data processing device recited in claim 1.
